(19) United States
(12) Patent Application Publication
(10) Pub. No.: US 2026/0338910 A1
(43) Pub. Date: Oct. 29, 2026

(54) APPARATUS AND METHOD FOR OBTAINING GROUND TRUTH TRAINING DATA FOR ENHANCED POSITIONING IN A COMMUNICATION NETWORK

(71) Applicant: Nokia Solutions and Networks Oy, Espoo (FI)

(72) Inventors: Athul PRASAD, Naperville, IL (US); Anil KIRMAZ, Munich (DE); Oana-Elena BARBU, Aalborg (DK); Diomidis MICHALOPOULOS, Munich (DE); Afef FEKI, Massy (FR); John HARRIS, Shorewood, WI (US); Dick CARRILLO MELGAREJO, Espoo (FI); Teemu Mikael VEIJALAINEN, Espoo (FI); Muhammad Ikram ASHRAF, Espoo (FI)

(21) Appl. No.: 19/116,168

(22) PCT Filed: Sep. 29, 2023
(86) PCT No.: PCT/EP2023/077013

§ 371 Date: Mar. 27, 2025

(30) Foreign Application Priority Data
Sep. 30, 2022 (FI) 20225872

(51) Int. Cl. G01S 5/02; H04W 24/02

(52) U.S. Cl. CPC G01S 5/0273; G01S 5/0278; H04W 24/02

(57) ABSTRACT

Apparatus and methods are proposed for use in a communication network comprising a plurality of positioning reference units and a plurality of transmission-reception points, wherein a positioning reference unit has a positioning reference unit location and is adapted for establishing a communication link with one or more transmission-reception points, the communication link being associated with an indicator subject to noise, the indicator having an indicator value.

The apparatus and method use a first learning model to obtain ground truth values for indicators that can be used for enhanced positioning of user equipment in the communication network.

One or more iterations of the following are performed:
training the first learning model with:
   as input features, positioning measurements received from the plurality of positioning reference units for a plurality of transmission-reception points, and indicators associated with the communication links between the positioning reference units and the transmission-reception points, and
   as output variables, predicted locations,
running inference of the first learning model to obtain predicted locations,
adjusting the values of the indicators to optimize a metric based on the positioning reference unit locations and the predicted locations.

### TECHNICAL FIELD

Various example embodiments relate generally to apparatus, methods, computer programs and data structures for use in a communication network.

In particular, the disclosed apparatus, methods, computer program and data structures apply to user equipment positioning in communication networks, for example in 5G systems.

### BACKGROUND

Positioning and 5G positioning is an important component in many 5G industrial use cases such as logistics, smart factories, autonomous vehicles, localized sensing, augmented and virtual reality.

Positioning accuracy enhancement with the use of machine learning is actively studied, e.g. within 3GGP RAN1 . In particular, the use of learning models has been proposed to predict user equipment locations based on various in field measurements.

A pre-requirement for using supervised machine learning models is to have access to labelled training data. Data labelling typically requires the support of external devices for in field measurements. For example, in 3GPP RAN1 positioning reference units are proposed to obtain labelled training data. However, considering the dynamic environment in which the positioning reference units are deployed, some of the measurements obtained from them may be noisy. Access to the ground truth information remains challenging.

### SUMMARY

According to some aspects, there is provided the subject matter of the independent claims. Some further aspects are defined in the dependent claims.

According to a first aspect, an apparatus is disclosed, for use in a communication network comprising a plurality of positioning reference units and a plurality of transmission-reception points, wherein a positioning reference unit has a positioning reference unit location and is adapted for establishing a communication link with one or more transmission-reception points, said communication link being associated with an indicator having an indicator value, the apparatus comprising circuitry configured to perform one or more iterations of:
training a first learning model with:
   as input features, positioning measurements received from the plurality of positioning reference units for a plurality of transmission-reception points, and indicators associated with the communication links between the positioning reference units and the transmission-reception points, and
   as output variables, predicted locations,
running inference of the first learning model to obtain predicted locations,
adjusting the values of the indicators to optimize a metric based on the positioning reference unit locations and the predicted locations.

An apparatus is also disclosed for use in a communication network comprising a plurality of positioning reference units and a plurality of transmission-reception points, wherein a positioning reference unit has a positioning reference unit location and is adapted for establishing a communication link with one or more transmission-reception points, said communication link being associated with an indicator having an indicator value, the apparatus comprising means for performing one or more iterations of
training a first learning model with:
   as input features, positioning measurements received from the plurality of positioning reference units for a plurality of transmission-reception points, and indicators associated with the communication links between the positioning reference units and the transmission-reception points, and
   as output variables, predicted locations,
running inference of the first learning model to obtain predicted locations,
adjusting the values of the indicators to optimize a metric based on the positioning reference unit locations and the predicted locations.

A method is also disclosed, for use in a communication network comprising a plurality of positioning reference units and a plurality of transmission-reception points, wherein a positioning reference unit has a positioning reference unit location and is adapted for establishing a communication link with one or more transmission-reception points, said communication link being associated with an indicator having an indicator value, the method comprising executing one or more iterations of:
training a first learning model with:
   as input features, positioning measurements received from the plurality of positioning reference units for a plurality of transmission-reception points, and indicators associated with the communication links between the positioning reference units and the transmission-reception points, an
   as output variables, predicted locations,
running inference of the first learning model to obtain predicted locations,
adjusting the values of the indicators to optimize a metric based on the positioning reference unit locations and the predicted locations.

In a first embodiment of said apparatus or method, the values of the indicators provided as input feature to the first learning model for the first iteration are received from the plurality of positioning reference units.

In another embodiment of said apparatus or method, the values of the indicators provided as input feature to the first learning model for the first iteration are set randomly.

In another embodiment of said apparatus or method, the indicator is a line-of-sight classifier or a time-based or power-based or angular measurement.

In another embodiment of said apparatus or method, the training comprises assessing a feature importance for said input features in the first learning model, comparing the importance of the indicator compared with the other features and removing the least important feature from the input features when the importance of the indicator is low compared with others.

In another embodiment of said apparatus or method, the metric is optimized by using a machine learning based method.

According to a second aspect, an apparatus is disclosed wherein said circuitry is further configured to send a dataset to a user equipment in the communication network, the dataset comprising at least received positioning measurements from a plurality of positioning reference units for a plurality of transmission-reception points wherein the values of the indicators are replaced with the adjusted values.

A method is also disclosed which further comprises sending a dataset to a user equipment in the communication network, the dataset comprising at least received positioning measurements from a plurality of positioning reference units for a plurality of transmission-reception points wherein the values of the indicators are replaced with the adjusted values.

In an embodiment of said apparatus and method, said dataset comprises the positioning reference units locations.

According to a third aspect, an apparatus is disclosed wherein said circuitry is further configured to:
train a second learning model to predict a value for the indicators, by using as training dataset the received positioning measurements wherein the values of the indicators are replaced with the adjusted values,
signal availability of the second learning model to at least one user equipment in the communication network,
run inference of the second learning model based on positioning measurements received from the user equipment for obtaining a predicted value for the indicator, and
send the predicted value to the user equipment.

A method is also disclosed which comprises:
training a second learning model to predict a value for the indicators, by using as training dataset the received positioning measurements wherein the values of the indicators are replaced with the adjusted values,
signaling availability of the second learning model to at least one user equipment in the communication network,
running inference of the second learning model based on positioning measurements received from the user equipment for obtaining a predicted value for the indicator, and
sending the predicted value to the user equipment.

According to a fourth aspect, a computer program is disclosed comprising instructions which, when executed by an apparatus for use in a communication network comprising a plurality of positioning reference units and a plurality of transmission-reception points, wherein a positioning reference unit has a positioning reference unit location and is adapted for establishing a communication link with one or more transmission-reception points, said communication link being associated with an indicator having an indicator value, cause the apparatus to perform one or more iterations of:
training a first learning model with:
   as input features, positioning measurements received from the plurality of positioning reference units for a plurality of transmission-reception points, and indicators associated with the communication links between the positioning reference units and the transmission-reception points, and
   as output variables, predicted locations,
running inference of the first learning model to obtain predicted locations,
adjusting the values of the indicators to optimize a metric based on the positioning reference unit locations and the predicted locations.

According to a fifth aspect, a data structure is disclosed for providing a dataset to a user equipment in a communication network comprising a plurality of positioning reference units and a plurality of transmission-reception points, the dataset comprising at least received positioning measurements from a plurality of positioning reference units for a plurality of transmission-reception points wherein the values of the indicators are replaced with adjusted values obtained by a method as disclosed above.

### BRIEF DESCRIPTION OF THE DRAWINGS

Example embodiments will become more fully understood from the detailed description given herein below and the accompanying drawings, which are given by way of illustration only and thus are not limiting of this disclosure.

FIG. 1 is a schematic representation of an example of communication network.

FIG. 2 is a schematic representation of a first example of a machine learning-based positioning approach.

FIG. 3 is a schematic representation of a second example of a machine learning-based positioning approach.

FIG. 4 is a high-level block diagram describing an example of method for obtaining ground truth values for indicators as disclosed herein.

FIG. 5 is flow chart describing further aspects of a method for obtaining ground truth values for indicators as disclosed herein.

FIG. 6 is a diagram illustrating the evolution of a line-of-sight classifier in a specific embodiment of the disclosure.

FIG. 7 is a high-level block diagram describing an example of a method for obtaining a predicted value for an indicator as disclosed herein.

FIG. 8 is a signaling flow diagram of a first exemplary embodiment of a method for obtaining a predicted value for an indicator as disclosed herein.

FIG. 9 is a signaling flow diagram of a second exemplary embodiment of a method for obtaining a predicted value for an indicator as disclosed herein.

FIG. 10 is diagram showing an example of datasets exchanges between entities in the communication network when the indicator is a line-of-sight classifier flag.

FIG. 11 is a schematic diagram of an example embodiment of an apparatus comprising circuitry configured to perform the methods described herein.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment and should not be interpreted as defining or limiting the range of values or properties encompassed by example embodiments. The use of similar or identical reference numbers in the various drawings is intended to indicate the presence of a similar or identical element or feature.

### DETAILED DESCRIPTION

Various example embodiments will now be described more fully with reference to the accompanying drawings in which some example embodiments are shown.

Detailed example embodiments are disclosed herein. However, specific structural and functional details disclosed herein are merely representative for purposes of describing example embodiments. The example embodiments may, however, be embodied in many alternate forms and should not be construed as limited to only the embodiments set forth herein. Accordingly, while example embodiments are capable of various modifications and alternative forms, the embodiments are shown by way of example in the drawings and will be described herein in detail. It should be understood, however, that there is no intent to limit example embodiments to the particular forms disclosed.

In the following, different exemplary embodiments will be described using, as an example of an access architecture to which the exemplary embodiments may be applied, a radio access architecture based on new radio NR (or 5G, 5G new radio), and a next generation core network NGC (or 5G Core, 5GC), without restricting the exemplary embodiments to such architectures, however. Such architecture may be, for example, so called 5G Advanced network, that is being specified in 3GPP starting from Release 18. Such architectures may also relate to future 6G networks. It is obvious for a person skilled in the art that the exemplary embodiments may also be applied to other kinds of communications networks having suitable means by adjusting parameters and procedures appropriately.

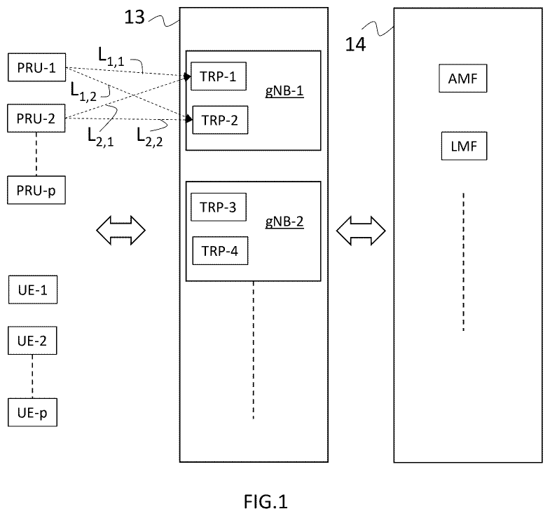

In an embodiment depicted in FIG. 1, a communication network 10 comprises a plurality of user equipment UE-1, UE-2, . . ., a plurality of positioning reference units PRU-1, PRU-2, . . . , a radio access network 13, a core network 14. The radio access network 13 comprises a plurality of base stations gNB-1, gNB-2, . . . , and the base stations comprise one or more transmission-reception points TRP-1, TRP-2. The core network 14 comprises several network entities hosting various functions, for example an access and mobility management Function AMF and a location management function LMF. In the present specification and figures, a core network entity, or a CN node may also be referred to as the LMF node or the LMF. The positioning reference units PRU have positioning reference unit locations and are adapted for establishing communication links with transmission-reception points TRP-1, TRP-2, etc.

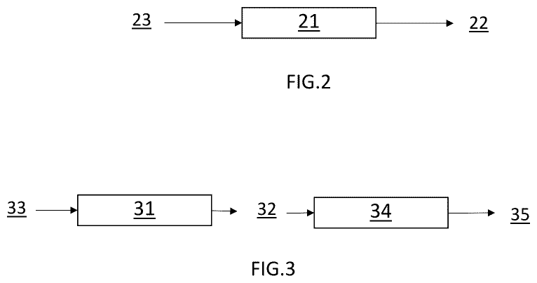

FIG. 2 is a schematic representation of a one-step positioning approach for positioning user equipment in a communication network. In this one-step positioning approach a supervised machine learning model 21 is used to predict a user equipment location 22 based on various in field measurements 23 received from the user equipment and used as input features by the learning model 21. The learning model 21 can be deployed at a user equipment UE-1, UE-2, etc. or at a network entity, for example a base station gNB or a location management function LMF.

FIG. 3 is a schematic representation of a two-step positioning approach for positioning user equipment in a communication network. In this two-step positioning approach, a first supervised machine learning model 31 is used to predict an intermediate feature 32 based on various in field measurements 33 received from a user equipment and used as input features by the first learning model 31. The intermediate feature is then used as input feature by a second learning model 34 to predict the user equipment location 35. Alternatively, the intermediate feature can be used through a classical method, not based on machine learning, to derive the user equipment location. In this two-step scenario, the two steps can be implemented in one single entity or in separate entities. For example, the two steps can be implemented in a network entity for example a base station gNB or a location management function LMF. Or the first learning model 31 can be deployed in a user equipment 11 and the second learning model 34 can be deployed in a network entity, for example a gNB or a LMF. Or the first learning model 31 can be deployed in a first user equipment UE-1 and the second learning model can be deployed in a second user equipment UE-2. These examples are not limitative.

For example, the field measurements 23 or 33 include various channel observations in particular positioning measurements such as time-based measurements e.g. Reference Signal Time Difference (RSTD), power-based measurements e.g. Reference Signal Received Power (RSRP), angle-based measurements e.g. Angle of Arrival (AoA) and/or Angle of Departure (AoD), line-of-sight classifier (e.g. LOS/NLOS), cells identifiers, beam identifiers, Channel Impulse Response (CIR), etc. . . .

The first supervised machine learning models 21 and 31 need to be trained with labelled training data.

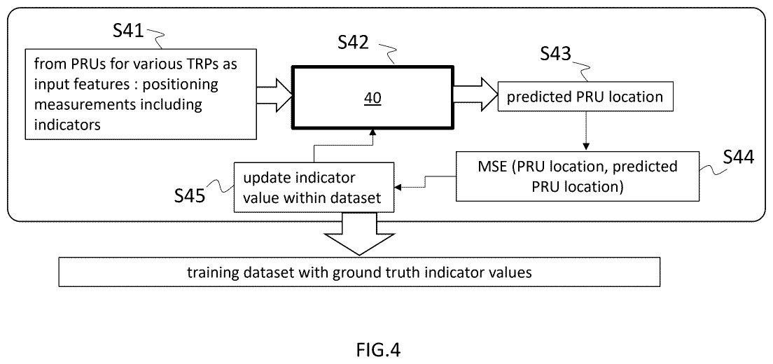

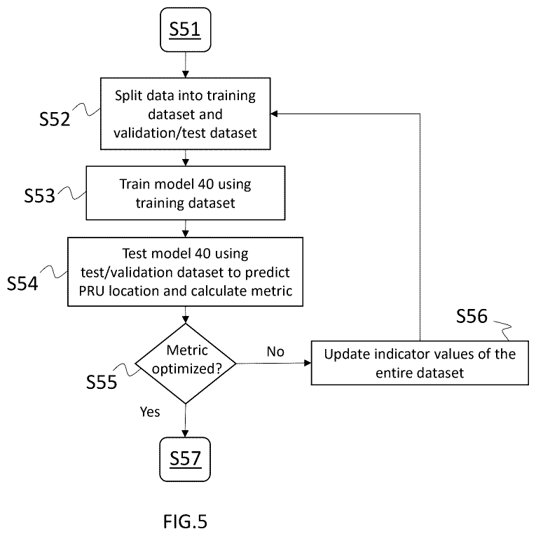

A method to obtain ground truth training data will now be described with reference to FIG. 4 to FIG. 10. This method is implemented by an apparatus in the communication network, for example a user equipment or a network entity.

In an embodiment described with reference to FIG. 4, the method for obtaining ground truth training data comprises a first step S41 of collecting positioning measurements from a plurality of positioning reference units PRU-1, PRU-2, etc. for a plurality of transmission-reception points TRP-1, TRP-2, etc. For a particular communication link Li,j between a particular positioning reference unit PRU-i and a particular transmission-reception point TRP-j the positioning measurements include for example time-based measurements (e.g. RSTD), power-based measurements (e.g. RSRP), angle-based measurements (e.g. AoA and/or AoD), line-of-sight classifier (e.g. LOS/NLOS), etc. The positioning measurements associated with a particular communication link Li,j include an indicator which reported value is subject to noise. The positioning measurements collected at step S1 are provided as input features to a machine learning model 40, referred to as ground truth learning model in the following of the description. For example, the ground truth learning model 40 may be a RF fingerprint-based machine learning model. This example is not limitative.

At step S42, positioning measurements collected at step S41 are used to train the ground truth learning model 40 to deliver predicted locations as output variables.

At step S43, a first inference of the ground truth learning model 40 is run to obtain predicted locations for the positioning reference units.

At step S44, a metric based on the actual positioning reference unit locations and the predicted locations obtained at step S43 is calculated. For example, the metric is a Mean Square Error (MSE). The actual positioning reference unit locations are transmitted by the positioning reference units together with the positioning measurements or they are otherwise known from the apparatus implementing the method.

At step S45 the values of the indicators are adjusted to optimize the metric. The adjusted values are used to execute a new iteration of the method starting from step S42 with the adjusted values replacing the previous values of the indicators. One or more iterations of the method are performed until the metric is optimized (e.g. when the MSE is minimized). For each iteration newly adjusted values are obtained which are used for the next iteration in replacement to the previous values of the indicators. The final adjusted values of the indicators are the ground truth value of the indicators.

In an embodiment described with reference to FIG. 5, at step S51 positioning measurements are received from a plurality of positioning reference units PRU-1, PRU-2, etc. for a plurality of transmission-reception points TRP-1, TRP-2, etc. At step S52, the received dataset is split into a training dataset and a validation/test dataset. At step S53, the ground truth learning model 40 is trained using the training dataset to predict the positioning reference unit locations. At step S54, an inference of the ground truth learning model 40 is run with the validation/test dataset to predict the positioning reference unit locations and a metric is calculated between the predicted positioning reference unit locations and the actual locations. The calculated metric is checked at step S55. When the metric is not optimized, the method continues with step S56. At step S56 the values of the indicators are adjusted. The adjusted values are used to execute a new iteration of the method starting from step S52 with the adjusted values replacing the previous values of the indicators. When the metric is optimized, the method terminates at step S57. The final adjusted values of the indicators are the ground truth value of the indicators.

Optionally, the value of the noisy indicators reported by the positioning reference units are ignored and randomly chosen indicator values are appended to the other positioning measurements.

In the training step S42 or S53 the ground truth learning model 40 is trained by minimizing the distance between true and predicted locations of the positioning reference units. The outcome of this step is a model parameterization, where the input features are weighted and then combined in an input layer, before being sent to the hidden layers. The first set of weights applied at the input layer is indicative of how important each of the input features is to the model. For example, a small or zero weight signifies no-importance, which means that the input feature does not contribute to the outcome of the model. Conversely a high weight indicates that the feature is relevant in producing the outcome of the model. To avoid a situation in which the importance of the indicator is set low by the model, the method optionally comprises a feature importance evaluation step and potentially a feature reselection step, after the training period. For example, the following procedure may be applied:
a) Train the ground truth learning model 40 using an input features set, where the features are selected amongst the positioning measurements and include the indicator.
b) Check the feature importance for the features in the input features set and assess how the indicator scores among the features, for example how high its importance is relative to the most important vs. least important feature (e.g. in which percentile the indicator is).
c) Assess whether the indicator importance is high/low depending on the outcome of step b). For example, if the flag is in the x^{th} percentile, where x=60, 70, etc., then conclude that the indicator is deemed important by the trained model. Then, stop the training and start running inference of the learning model.
d) If the flag importance is low, then go back to step a) and prune the input features set, by removing one or more of the least important features obtained at step b). Repeat steps a) to c).

If the indicator for which the ground truth is being estimated is the feature of least importance, it is not necessary to estimate its ground truth. In this case, the ground truth estimation process is omitted.

The goal of the inference step S43 or S54 is to estimate the true indicator value fₖ such that the inferred positioning reference unit location using this indicator is close or equal to the real positioning reference unit location: find fᵢ subject to MSE {x|fₖ, xₜᵣᵤₑ} is minimized, where x|fₖ is the position estimated using the values fₖ of the indicator for different transmission-reception points and xₜᵣᵤₑ refers to the true location of the positioning reference unit.

The complexity of this search depends on the number of communication links Li,j between positioning reference units PRU-i and transmission-reception points TRP-j and the type of indicator. When the number of communication links is low and when the indicator is a binary flag (taking values 0 or 1), it is straightforward to perform exhaustive search to get the value fₖ which minimizes the mean square error. However, when the number of communication links is high and when the indicator is a soft value (e.g. with a step of 0.1 between 0 and 1), the number of possibilities can become high. For this reason, optionally, a machine learning-based method can be used to steer the exploration over the space of possibilities and converge to the optimal value (for example a trial-and-error algorithm).

The adjustment step S45 or S56 will now be described in more details in an exemplary embodiment where the noisy indicator is a line-of-sight classifier. A line-of-sight (LOS) classifier indicates blockage in a particular communication link. Blockage over a communication link can be static or dynamic. Having access to ground truth values for line-of-sight classifiers is important for accurate positioning of user equipment, particularly in dynamic environments. For example, a positioning algorithm (such as described with reference to FIG. 2 and FIG. 3) may determine the user equipment location with higher accuracy by allocating lower weights to non-light-of-sight communication links (i.e. non-line-of-sight link also referred to as NLOS links) or using other optimization mechanisms

Blockage can be due to different types of blockers, for example heavy blockers like metal, medium blockers like wood, or light blockers like humans. Some blockers are static while others are mobile. The format of the line-of-sight classifier can be chosen depending on the reality of the environment and the variety of blockers.

In a first example, the line-of-sight classifier provides a binary information and is referred to as line-of-sight flag. In this first example, at step S45 or S56, the line-of-sight flag is updated with random or alternating values of 0 and 1 until the metric between the predicted locations and actual positioning reference until locations is optimized, thereby estimating the ground truth values of the line-of-sight flag.

In a second example, the line-of-sight classifier is a multi-class information (more than binary), referred to as line-of-sight field. In this second example, at step S45 or S56, the line-of-sight field is updated with random integer values between 0 and N−1 (N being the number of classes), until the metric between the predicted locations and actual positioning reference until locations is optimized, thereby estimating the ground truth values of the line-of-sight field.

In a third example, received line-of-sight flag values may be converted into soft values e.g. values between 0.0 and 1.0 in order to enable a larger number of combinations while running the ground truth learning model 40 and optimizing the metric. In this third example, at step S45 or S56, the soft value is randomly or incrementally updated until the metric between the predicted locations and actual positioning reference until locations is optimized, thereby estimating the ground truth values of the line-of-sight field.

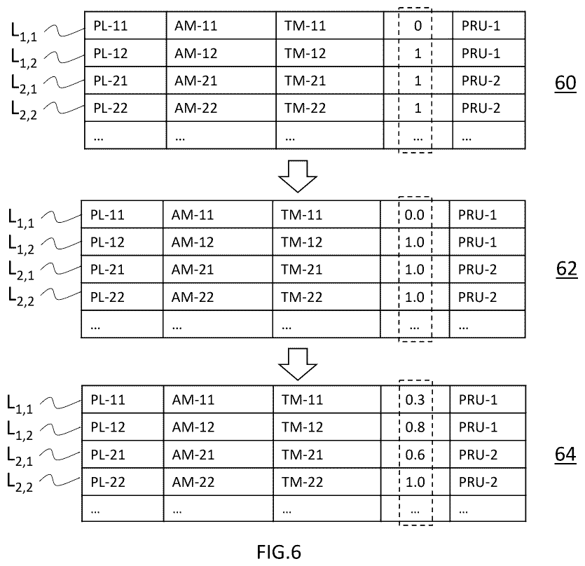

FIG. 6 depicts an example of a dataset 60 received at step S41 or S51 which comprises positioning measurements corresponding to four communication links L11, L12, L21 and L22 between two positioning reference units PRU-1 and PRU-2 and two transmission-reception points TRP-1 and TRP-2. The positioning measurements comprise, in association with communication links L11, L12, L21 and L22 respectively:
power levels PL-11, PL-12, PL-21 and PL-22;
angular measurements AM-11, AM-12, AM-21 and AM-22;
time-based measurements TM-11, TM-12, TM-21 and TM-22;
line-of-sight flag values 0, 1, 1, and 1.

The line-of-sight flag values of the received dataset 60 may be converted into soft values e.g. values between 0.0 and 1.0 to obtain a converted dataset 62. In FIG. 6, the converted dataset 62 comprises line-of-sight soft values 0.0, 1.0, 1.0 and 1.0 in association with communication links L11, L12, L21 and L22 respectively.

The converted dataset 62 is used as input features for the ground truth learning model 40. A final dataset 64 is obtained through one or more iterations of the method. The final dataset 64 comprises adjusted line-of-sight soft values 0.3, 0.8, 0.6 and 1.0 in association with communication links L11, L12, L21 and L22 respectively. These adjusted line-of-sight soft values are the ground truth values of the line-of-sight classifier.

The method described above for obtaining ground truth training data is implemented in an apparatus in the communication network. In an embodiment, it is implemented in a base station gNB or in a network entity hosting a location management function LMF. In another embodiment it is implemented at a user equipment.

The present disclosure further relates to the generation of a predicted value for an indicator based on labeled training data obtained through the above-described method for obtaining ground truth training data.

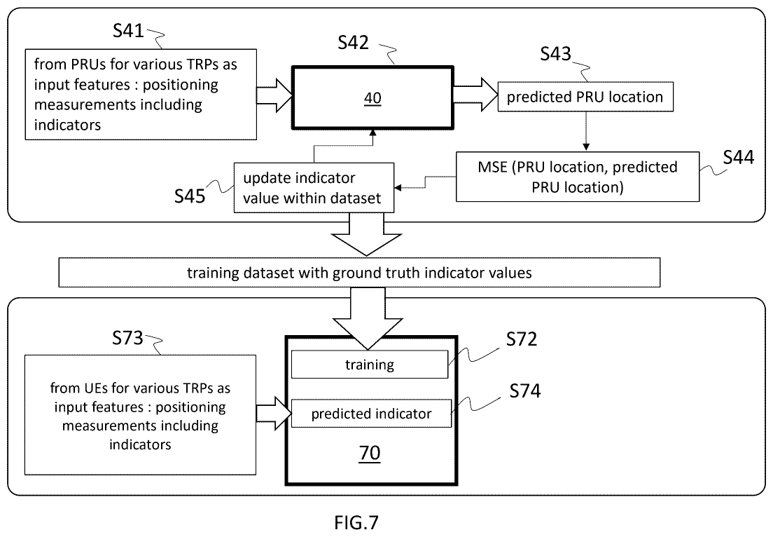

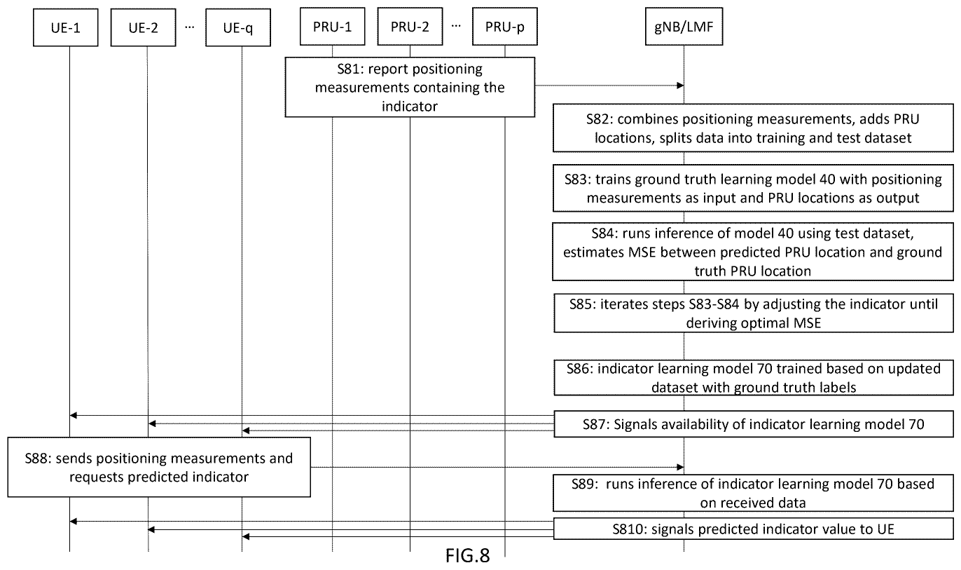

In an embodiment depicted in FIG. 7, the final dataset 64 is used to train a machine learning model 70, referred to as indicator learning model. At step S72, the indicator learning model 70 is trained. Then, at step S73, positioning measurements are obtained from a user equipment. At step S74 inferences of the indicator learning model 70 are run based on the received positioning measurements and predicted values for the indicators are obtained at step S76. For example, the predicted indicator values are then used for user equipment positioning for example with a one-step positioning approach as described with reference to FIG. 2 or a two-step positioning approach as described with reference to FIG. 3.

In an embodiment, the indicator learning model 70 is deployed at the network side, for example in a base station gNB, or in a network entity hosting a location management function LMF. In another embodiment the indicator learning model 70 is deployed at the user equipment UE side.

FIG. 8 is a first example of a signaling flow diagram of a method as disclosed herein when both the ground truth learning model 40 and the indicator learning model 70 are deployed in a network entity (e.g. gNB or LMF).

As depicted in FIG. 8, at step S81, reports containing positioning measurements including an indicator subject to noise, are sent by the positioning reference units PRU-1, PRU-2 to PRU-p to a network entity gNB/LMF. For example, the positioning measurements include power levels, angular/time-based measurements and a line-of-sight classifiers, and the noisy indicator is the line-of-sight classifier. At step S82, the network entity gNB/LMF combines received positioning measurements, adds the positioning reference unit locations, and split the data set into a training dataset and a test/validation dataset. At step S83, the network entity gNB/LMF trains the ground truth learning model 40 with the positioning measurements as input features and the predicted locations as output variables. At step S84, an inference of the ground truth learning model 40 is run using the test/validation dataset. The mean square error MSE is estimated between the predicted locations and the actual locations of the positioning reference units. At step S85, steps S83 and S84 are iterated by adjusting the value of the noisy indicator until deriving an optimal mean square error.

At step S86, the indicator learning model 70 is trained by the network entity gNB/LMF by using as training dataset the positioning measurements received at step S81 wherein the values of the noisy indicators are replaced with the adjusted values obtained at step S85. The indicator learning model 70 is trained to predict values for the indicators associated with communication links.

At step S87, the network entity signals availability of the indicator learning model 70 to the user equipment UE-1, UE-2 to UE-q in the communication network.

A step S88, a user equipment sends a measurement report to the network entity gNB/LMF containing positioning measurements (such as power levels, angular/time-based measurements) and request a predicted value for the indicator associated with the communication link between the user equipment and one or more transmission-reception points (such as a line-of-sight classifier value).

At step S89, the network entity gNB/LMF runs inference of the indicator learning model 70 based on the positioning measurements reported by the user equipment and obtains a predicted indicator value.

At step S810, the network entity gNB/LMF signals the predicted indicator value obtained at step S89 to the user equipment. For example, the predicted indicator value can be used by the user equipment for accurate estimation of the position of the user equipment.

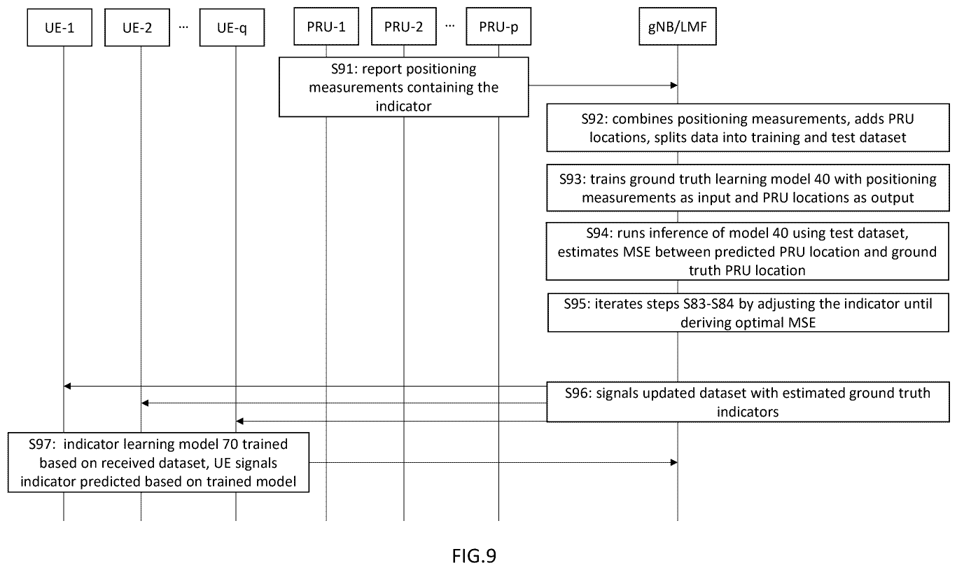

FIG. 9 is a second example of a signaling flow diagram of a method as disclosed herein when the ground truth learning model 40 is deployed in a network entity (e.g. gNB or LMF) and the indicator learning model 70 is deployed at the user equipment.

Steps S91 to S95 in FIG. 9 are similar to steps S81 to S85 described in relation to FIG. 8.

At step S96, the network entity gNB/LMF signals a training data set to the user equipment UE-1, UE-2 to UE-q. the training dataset comprises the positioning measurements received at step S91 wherein the values of the noisy indicators are replaced with the adjusted values obtained at step S95.

At step S97, the indicator learning model 70 hosted by the user equipment is trained to predict values for the indicators associated with communication links. The user equipment runs inference of the indicator learning model 70 based on positioning measurements as power levels, angular/time-based measurements and a line-of-sight classifiers associated with the communication link between the user equipment and one or more transmission-reception points. And the predicted values obtained by the user equipment is send to the network entity gNB/LMF. For example, the network entity gNB/LMF can use the predicted indicator values for accurate estimation of the position of the user equipment.

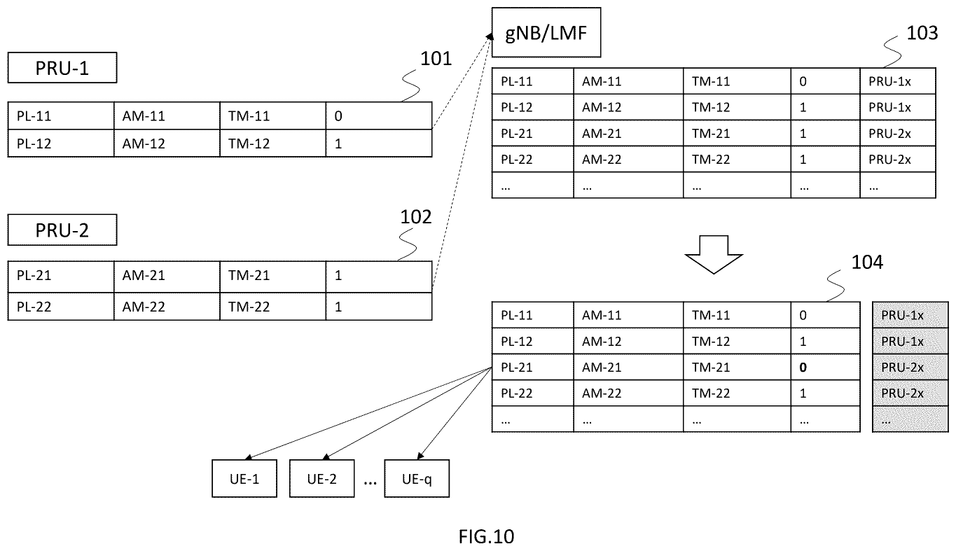

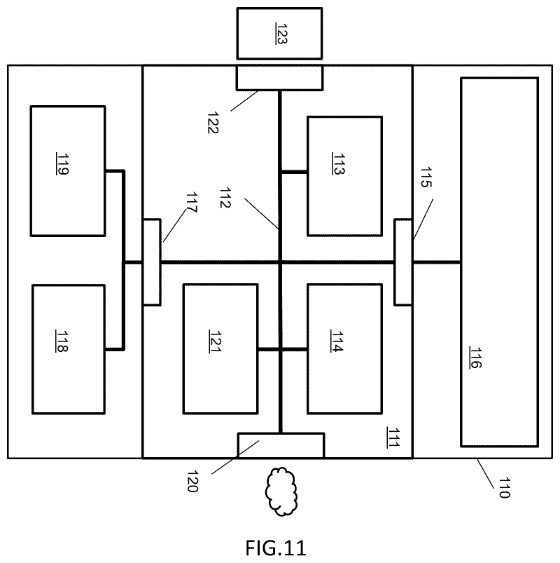

FIG. 10 illustrates datasets exchanges between two positioning reference units PRU-1 and PRU-2, a network entity gNB/LMF and user equipment UE-1, UE-2, . . . , UE-q when the indicator learning model 70 is deployed at the user equipment. In the example of FIG. 10 the indicator is a line-of-sight classifier flag, referred to as LOS/NLOS flag. This is not limitative.

The positioning reference units PRU-1 and PRU-2 PRUs send datasets 101 and 102 respectively to the network entity gNB/LMF. The datasets 101 and 102 comprise positioning measurements corresponding to four communication links L11, L12, L21 and L22 between the two positioning reference units PRU-1 and PRU-2 and two transmission-reception points TRP-1 and TRP-2. The positioning measurements may comprise in association with communication links L11, L12, L21 and L22 respectively:
power levels PL-11, PL-12, PL-21 and PL-22;
angular measurements AM-11, AM-12, AM-21 and AM-22;
time-based measurements TM-11, TM-12, TM-21 and TM-22;
line-of-sight flag values 0, 1, 1, and 1.

The network entity gNB/LMF utilizes the ground truth learning model 40 to estimate the ground truth value for the line-of-sight classifier. The received datasets 101 and 102 are combined and the locations of the positioning reference units PRU-1 and PRU-2 are appended to form a training data set 103 used to train the ground truth learning model 40.

A final dataset 104 is obtained through one or more iterations of the method for obtaining ground truth training data. In the example depicted in FIG. 10, the final dataset 104 comprises the positioning measurements in which the received line-of-sight flag values 0, 1, 1, and 1 are replaced with the adjusted line-of-sight flag values 0, 1, 0 and 1. The adjusted line-of-sight flag values are the ground truth values of the line-of-sight classifier.

The final data set 104 is signaled to the user equipment UE-1 to UE-q. Optionally the locations of the positioning reference units PRU-1 and PRU-2 are included in the final dataset 104.

Although the line-of-sight indicator has been used in the above description as an example of indicator, any other positioning measurements can be used as indicator for the purpose of implementing the method disclosed herein (for example power measurements, angular measurements, time-based measurements . . . ).

FIG. 11 depicts a high-level block diagram of an apparatus 110 suitable for implementing various aspects of the disclosure. Although illustrated in a single block, in other embodiments the apparatus 110 may also be implemented using parallel and distributed architectures. Thus, for example, various steps such as those illustrated in the apparatus and methods described above by reference to FIG. 2 to 10 may be executed using apparatus 110 sequentially, in parallel, or in a different order based on particular implementations.

According to an exemplary embodiment, depicted in FIG. 11, apparatus 110 comprises a printed circuit board 111 on which a communication bus 112 connects a processor 113 (e.g., a central processing unit “CPU”), a random access memory 114, a storage medium 121, an interface 115 for connecting a display 116, a series of connectors 117 for connecting user interface devices or modules such as a mouse or trackpad 118 and a keyboard 119, a wireless network interface 120 and a wired network interface 122. Depending on the functionality required, the apparatus may implement only part of the above. Certain modules of FIG. 11 may be internal or connected externally, in which case they do not necessarily form integral part of the apparatus itself. For example display 116 may be a display that is connected to the apparatus only under specific circumstances, or the apparatus may be controlled through another device with a display, i.e. no specific display 116 and interface 115 are required for such an apparatus. Memory 121 contains software code which, when executed by processor 113, causes the apparatus 110 to perform the methods described herein. Storage medium 123 is a detachable device such as a USB stick which holds the software code which can be uploaded to memory 121.

The processor 113 may be any type of processor such as a general purpose central processing unit (“CPU”) or a dedicated microprocessor such as an embedded microcontroller or a digital signal processor (“DSP”).

In addition, apparatus 110 may also include other components typically found in computing apparatus, such as an operating system, queue managers, device drivers, or one or more network protocols that are stored in memory 121 and executed by the processor 113.

Although aspects herein have been described with reference to particular embodiments, it is to be understood that these embodiments are merely illustrative of the principles and applications of the present disclosure. It is therefore to be understood that numerous modifications can be made to the illustrative embodiments and that other arrangements can be devised without departing from the spirit and scope of the disclosure as determined based upon the claims and any equivalents thereof.

For example, the data disclosed herein may be stored in various types of data structures which may be accessed and manipulated by a programmable processor (e.g., CPU or FPGA) that is implemented using software, hardware, or combination thereof.

It should be appreciated by those skilled in the art that any block diagrams herein represent conceptual views of illustrative circuitry embodying the principles of the disclosure. Similarly, it will be appreciated that any flow charts, flow diagrams, state transition diagrams, and the like represent various processes which may be substantially implemented by circuitry.

Each described function, engine, block, step can be implemented in hardware, software, firmware, middleware, microcode, or any suitable combination thereof. If implemented in software, the functions, engines, blocks of the block diagrams and/or flowchart illustrations can be implemented by computer program instructions/software code, which may be stored or transmitted over a computer-readable medium, or loaded onto a general purpose computer, special purpose computer or other programmable processing apparatus and/or system to produce a machine, such that the computer program instructions or software code which execute on the computer or other programmable processing apparatus, create the means for implementing the functions described herein.

In the present description, block denoted as “means configured to perform . . . ” (a certain function) shall be understood as functional blocks comprising circuitry that is adapted for performing or configured to perform a certain function. A means being configured to perform a certain function does, hence, not imply that such means necessarily is performing said function (at a given time instant). Moreover, any entity described herein as “means”, may correspond to or be implemented as “one or more modules”, “one or more devices”, “one or more units”, etc. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional or custom, may also be included. Their function may be carried out through the operation of program logic, through dedicated logic, through the interaction of program control and dedicated logic, or even manually, the particular technique being selectable by the implementer as more specifically understood from the context.

As used in this application, the term “circuitry” may refer to one or more or all of the following:
(a) hardware-only circuit implementations (such as implementations in only analog and/or digital circuitry), and
(b) combinations of hardware circuits and software, such as (as applicable):
   (i) a combination of analog and/or digital hardware circuit(s) with software/firmware, and
   (ii) any portions of hardware processor(s) with software (including digital signal processor(s)), software, and memory(ies) that work together to cause an apparatus, such as a mobile phone or server, to perform various functions), and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “and/or,” includes any and all combinations of one or more of the associated listed items.

When an element is referred to as being “connected,” or “coupled,” to another element, it can be directly connected or coupled to the other element or intervening elements may be present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Benefits, other advantages, and solutions to problems have been described above with regard to specific embodiments of the invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

In example 1, an apparatus is disclosed for use in a communication network comprising a plurality of positioning reference units and a plurality of transmission-reception points, wherein a positioning reference unit has a positioning reference unit location and is adapted for establishing a communication link with one or more transmission-reception points, said communication link being associated with an indicator having an indicator value, the apparatus comprising circuitry configured to perform one or more iterations of:
training a first learning model with:
   as input features, positioning measurements received from the plurality of positioning reference units for a plurality of transmission-reception points, and indicators associated with the communication links between the positioning reference units and the transmission-reception points, and
   as output variables, predicted locations,
running inference of the first learning model to obtain predicted locations,
adjusting the values of the indicators to optimize a metric based on the positioning reference unit locations and the predicted locations.

In example 2, an apparatus is disclosed for use in a communication network comprising a plurality of positioning reference units and a plurality of transmission-reception points, wherein a positioning reference unit has a positioning reference unit location and is adapted for establishing a communication link with one or more transmission-reception points, said communication link being associated with an indicator having an indicator value, the apparatus comprising means for performing one or more iterations of:
training a first learning model with:
   as input features, positioning measurements received from the plurality of positioning reference units for a plurality of transmission-reception points, and indicators associated with the communication links between the positioning reference units and the transmission-reception points, and
   as output variables, predicted locations,
running inference of the first learning model to obtain predicted locations,
adjusting the values of the indicators to optimize a metric based on the positioning reference unit locations and the predicted locations.

In example 3, the values of the indicators provided as input feature to the first learning model for the first iteration are received from the plurality of positioning reference units. Alternatively in example 4, the values of the indicators provided as input feature to the first learning model for the first iteration are set randomly. Example 3 and example 4 are used in combination with examples 1 or 2.

In example 5, the indicator is a line-of-sight classifier or a time-based or power-based or angular measurement. Example 5 is used in combination with examples 1 or 2. It can also be used in any combination of examples 1 and 3 or 4, or any combination of examples 2 and 3 or 4.

In example 6, training comprises assessing a feature importance for said input features in the first learning model, comparing the importance of the indicator compared with the other features and removing the least important feature from the input features when the importance of the indicator is low compared with others. Example 6 is used in combination with examples 1 or 2. It can also be used in any combination of examples 1, 3, and 5, or 1, 4 and 5 or in any combination of examples 2, 3, and 5, or 2, 4 and 5.

In example 7, the metric is optimized by using a machine learning based method. Example 7 is used in combination with examples 1 or 2. It can also be used in any combination of examples 1, 3, 5 and 6, or 1, 4, 5 and 6, and in any combination of examples 2, 3, 5, and 6, or 2, 4, 5, and 6.

In example 8, said circuitry is further configured to send a dataset to a user equipment in the communication network, the dataset comprising at least received positioning measurements from a plurality of positioning reference units for a plurality of transmission-reception points wherein the values of the indicators are replaced with the adjusted values. Example 8 is used in combination with example 1. It can also be used in any combination of examples 1, 3, 5, 6 and 7, or 1, 4, 5, 6 and 7.

Alternatively, in example 9, said circuitry is further configured to:
train a second learning model to predict indicators, by using as training dataset the received positioning measurements wherein the values of the indicators are replaced with the adjusted values,
signal availability of the second learning model to at least one user equipment in the communication network,
run inference of the second learning model based on positioning measurements received from the user equipment for obtaining a predicted value for the indicator, and
send the predicted value to the user equipment.

Example 9 is used in combination with example 1. It can also be used in any combination of examples 1, 3, 5, 6 and 7, or 1, 4, 5, 6 and 7.

In example 10, the apparatus further comprises means for sending a dataset to a user equipment in the communication network, the dataset comprising at least received positioning measurements from a plurality of positioning reference units for a plurality of transmission-reception points wherein the values of the indicators are replaced with the adjusted values. Example 10 is used in combination with example 2. It can also be used in any combination of examples 2, 3, 5, 6 and 7, or 2, 4, 5, 6 and 7.

Alternatively, in example 11, the apparatus further comprises means for:
training a second learning model to predict indicators, by using as training dataset the received positioning measurements wherein the values of the indicators are replaced with the adjusted values,
signaling availability of the second learning model to at least one user equipment in the communication network,
running inference of the second learning model based on positioning measurements received from the user equipment for obtaining a predicted value for the indicator, and
sending the predicted value to the user equipment.

Example 11 can also be used in any combination of examples 2, 3, 5, 6 and 7, or 2, 4, 5, 6 and 7.

In example 12, the dataset comprises the positioning reference units locations. Example 12 is used in combination with example 10.

In example 13, a method is disclosed for use in a communication network comprising a plurality of positioning reference units and a plurality of transmission-reception points, wherein a positioning reference unit has a positioning reference unit location and is adapted for establishing a communication link with one or more transmission-reception points, said communication link being associated with an indicator having an indicator value, the method comprising executing one or more iterations of:
training a first learning model with:
   as input features, positioning measurements received from the plurality of positioning reference units for a plurality of transmission-reception points, and indicators associated with the communication links between the positioning reference units and the transmission-reception points, an
   as output variables, predicted locations,
running inference of the first learning model to obtain predicted locations,
adjusting the values of the indicators to optimize a metric based on the positioning reference unit locations and the predicted locations.

In example 14, the values of the indicators provided as input feature to the first learning model for the first iteration are received from the plurality of positioning reference units. Alternatively, in example 15, the values of the indicators provided as input feature to the first learning model for the first iteration are set randomly. Example 14 and example 15 are used in combination with example 13.

In example 16, the indicator is a line-of-sight classifier or a time-based or power-based or angular measurement. Example 16 is used in combination with examples 13. It can also be used in combination with examples 13 and 14, or 13 and 15.

In example 17, training comprises assessing a feature importance for said input features in the first learning model, comparing the importance of the indicator compared with the other features and removing the least important feature from the input features when the importance of the indicator is low compared with others. Example 17 is used in combination with examples 13. It can also be used in any combination of examples 13, 14 and 16, or any combination of examples 13, 15 and 16.

In example 18, the metric is optimized by using a machine learning based method. Example 18 is used in combination with examples 13. It can also be used in any combination of examples 13, 14, 16 and 17, or any combination of examples 13, 15, 16 and 17.

In example 19, the method further comprises sending a dataset to a user equipment in the communication network, the dataset comprising at least received positioning measurements from a plurality of positioning reference units for a plurality of transmission-reception points wherein the values of the indicators are replaced with the adjusted values. In this embodiment, optionally the dataset comprises the positioning reference units locations. In an alternative embodiment. Example 19 is used in combination with examples 13. It can also be used in any combination of examples 13, 14, 16, 17 and 18, or any combination of examples 13, 15, 16, 17 and 18.

Alternatively, in example 20, the method further comprises:
training a second learning model to predict indicators, by using as training dataset the received positioning measurements wherein the values of the indicators are replaced with the adjusted values,
signaling availability of the second learning model to at least one user equipment in the communication network,
running inference of the second learning model based on positioning measurements received from the user equipment for obtaining a predicted value for the indicator, and
sending the predicted value to the user equipment.

Example 20 is used in combination with examples 13. It can also be used in any combination of examples 13, 14, 16, 17 and 18, or any combination of examples 13, 15, 16, 17 and 18.

In example 21, the dataset comprises the positioning reference units locations. Example 21 is used in combination with example 19.

In example 22, a computer program is disclosed, comprising instructions which, when executed by an apparatus for use in a communication network comprising a plurality of positioning reference units and a plurality of transmission-reception points, wherein a positioning reference unit has a positioning reference unit location and is adapted for establishing a communication link with one or more transmission-reception points, said communication link being associated with an indicator having an indicator value, cause the apparatus to perform one or more iterations of:
training a first learning model with:
   as input features, positioning measurements received from the plurality of positioning reference units for a plurality of transmission-reception points, and indicators associated with the communication links between the positioning reference units and the transmission-reception points, and
   as output variables, predicted locations,
running inference of the first learning model to obtain predicted locations,
adjusting the values of the indicators to optimize a metric based on the positioning reference unit locations and the predicted locations.

In example 23, a data structure is disclosed for providing a dataset to a user equipment in a communication network comprising a plurality of positioning reference units and a plurality of transmission-reception points, the dataset comprising at least received positioning measurements from a plurality of positioning reference units for a plurality of transmission-reception points wherein the values of the indicators are replaced with adjusted values obtained by a method as disclosed in example 13 or in any combination of examples 13, 14, 16, 17, 18, 19 and 21, or any combination of examples 13, 15, 16, 17, 18, 19 and 21.

1. An apparatus for use in a communication network comprising a plurality of positioning reference units and a plurality of transmission-reception points, wherein a positioning reference unit has a positioning reference unit location and is adapted for establishing a communication link with one or more transmission-reception points, said communication link being associated with an indicator having an indicator value, the apparatus comprising circuitry configured to perform one or more iterations of:
training a first learning model with:
as input features, positioning measurements received from the plurality of positioning reference units for a plurality of transmission-reception points, and indicators associated with the communication links between the positioning reference units and the transmission-reception points, and
as output variables, predicted locations,
running inference of the first learning model to obtain predicted locations,
adjusting the values of the indicators to optimize a metric based on the positioning reference unit locations and the predicted locations.

2. An apparatus as claimed in claim 1, wherein the values of the indicators provided as input feature to the first learning model for the first iteration are received from the plurality of positioning reference units.

3. An apparatus as claimed in claim 1, wherein the values of the indicators provided as input feature to the first learning model for the first iteration are set randomly.

4. An apparatus as claimed in claim 1, wherein the indicator is a line-of-sight classifier or a time-based or power-based or angular measurement.

5. An apparatus as claimed in claim 1, wherein training comprises assessing a feature importance for said input features in the first learning model, comparing the importance of the indicator compared with the other features and removing the least important feature from the input features when the importance of the indicator is low compared with others.

6. An apparatus as claimed in claim 1, wherein the metric is optimized by using a machine learning based method.

7. An apparatus as claimed in claim 1, wherein said circuitry is further configured to send a dataset to a user equipment in the communication network, the dataset comprising at least received positioning measurements from a plurality of positioning reference units for a plurality of transmission-reception points wherein the values of the indicators are replaced with the adjusted values.

8. An apparatus as claimed in claim 1, wherein said circuitry is further configured to:
train a second learning model to predict indicators, by using as training dataset the received positioning measurements wherein the values of the indicators are replaced with the adjusted values,
signal availability of the second learning model to at least one user equipment in the communication network,
run inference of the second learning model based on positioning measurements received from the user equipment for obtaining a predicted value for the indicator, and
send the predicted value to the user equipment.

9. An apparatus as claimed in claim 7, wherein the dataset comprises the positioning reference units locations.

10. A method for use in a communication network comprising a plurality of positioning reference units and a plurality of transmission-reception points, wherein a positioning reference unit has a positioning reference unit location and is adapted for establishing a communication link with one or more transmission-reception points, said communication link being associated with an indicator having an indicator value, the method comprising executing one or more iterations of:
training a first learning model with:
as input features, positioning measurements received from the plurality of positioning reference units for a plurality of transmission-reception points, and indicators associated with the communication links between the positioning reference units and the transmission-reception points, an
as output variables, predicted locations,
running inference of the first learning model to obtain predicted locations,
adjusting the values of the indicators to optimize a metric based on the positioning reference unit locations and the predicted locations.

11. A method as claimed in claim 10, wherein the values of the indicators provided as input feature to the first learning model for the first iteration are received from the plurality of positioning reference units.

12. A method as claimed in claim 10, wherein the values of the indicators provided as input feature to the first learning model for the first iteration are set randomly.

13. A method as claimed in claim 10, wherein the indicator is a line-of-sight classifier or a time-based or power-based or angular measurement.

14. A method as claimed in claim 10, wherein training comprises assessing a feature importance for said input features in the first learning model, comparing the importance of the indicator compared with the other features and removing the least important feature from the input features when the importance of the indicator is low compared with others.

15. A method as claimed in claim 10, wherein the metric is optimized by using a machine learning based method.

16. A method as claimed in claim 10, further comprising sending a dataset to a user equipment in the communication network, the dataset comprising at least received positioning measurements from a plurality of positioning reference units for a plurality of transmission-reception points wherein the values of the indicators are replaced with the adjusted values.

17. A method as claimed in claim 10, further comprising:
training a second learning model to predict indicators, by using as training dataset the received positioning measurements wherein the values of the indicators are replaced with the adjusted values,
signaling availability of the second learning model to at least one user equipment in the communication network,
running inference of the second learning model based on positioning measurements received from the user equipment for obtaining a predicted value for the indicator, and
sending the predicted value to the user equipment.

18. A method as claimed in claim 16, wherein the dataset comprises the positioning reference units locations.

19. A computer program comprising instructions which, when executed by an apparatus for use in a communication network comprising a plurality of positioning reference units and a plurality of transmission-reception points, wherein a positioning reference unit has a positioning reference unit location and is adapted for establishing a communication link with one or more transmission-reception points, said communication link being associated with an indicator having an indicator value, cause the apparatus to perform one or more iterations of:
training a first learning model with:
as input features, positioning measurements received from the plurality of positioning reference units for a plurality of transmission-reception points, and indicators associated with the communication links between the positioning reference units and the transmission-reception points, and
as output variables, predicted locations,
running inference of the first learning model to obtain predicted locations,
adjusting the values of the indicators to optimize a metric based on the positioning reference unit locations and the predicted locations.

20. (canceled)
